(19) United States
(12) Patent Application Publication
(10) Pub. No.: US 2008/0147940 A1
(43) Pub. Date: Jun. 19, 2008

(54) METHOD AND APPARATUS FOR CONTROLLING A SHARED BUS

(76) Inventors: Rom-Shen Kao, Durham, NC (US); Jong-Hoon Oh, Chapel Hill, NC (US)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/612,378

(22) Filed: Dec. 18, 2006

(51) Int. Cl. G06F 13/00

(52) U.S. Cl. 710/107

(57) ABSTRACT

Methods and apparatus for controlling a shared bus. The shared bus is shared between a volatile memory device via a nonvolatile memory interface of the volatile memory and two or more nonvolatile memory controllers. In one embodiment, a method includes receiving a request from a first nonvolatile memory controller of the two or more nonvolatile memory controllers for control of the shared bus. In response to receiving the request, control of the shared bus is granted to the first nonvolatile memory controller if the priority for each of the two or more nonvolatile memory controllers indicates that control should be granted. When control is granted to the first nonvolatile memory controller, the first nonvolatile memory controller is the only nonvolatile memory controller of the two or more nonvolatile memory controllers which performs data access operations via the shared bus.

### CROSS-REFERENCE TO RELATED APPLICATIONS

This application is related to U.S. patent application Ser. No. 11/456,061, Attorney Docket No. QIMO/0263, entitled CONTROL PROTOCOL AND SIGNALING IN A NEW MEMORY ARCHITECTURE, filed Jul. 6, 2006, by Rom-Shen Kao, U.S. patent application Ser. No. 11/456,063, Attorney Docket No. QIMO/0267, entitled METHOD FOR ACCESSING A NON-VOLATILE MEMORY VIA A VOLATILE MEMORY INTERFACE, filed Jul. 6, 2006, by Rom-Shen Kao, U.S. patent application Ser. No. 11/456,064, Attorney Docket No. QIMO/0268, entitled SYSTEM AND METHOD FOR ISSUING COMMANDS, filed Jul. 6, 2006, by Rom-Shen Kao, and U.S. patent application Ser. No. 11/456,067, Attorney Docket No. QIMO/0269, entitled METHOD FOR ACCESSING CONTROL REGISTERS VIA A MEMORY DEVICE, filed Jul. 6, 2006, by Rom-Shen Kao. Each of these related patent applications are herein incorporated by reference respectively in its entirety.

### BACKGROUND OF THE INVENTION

Many modern electronic devices such as cell phones, PDAs, portable music players, appliances, and so on typically incorporate an embedded computer system. An embedded computer system typically contains a computer processor (referred to as a host), non-volatile memory (such as a flash memory and/or ROM memory), and volatile memory such as a dynamic random access memory (DRAM). The host may include a central processing unit (CPU), digital signal processor (DSP), microcontroller unit (MCU) or direct memory access (DMA) data transmission device. The embedded system may also include a nonvolatile memory controller which may be used to control and/or access the nonvolatile memory.

In the embedded system, the volatile memory may typically be accessed more quickly than non-volatile memory. Thus, for example, code executed by the host may be stored in the volatile memory and accessed from the volatile memory by the host. However, because volatile memory typically requires a power source to maintain data stored therein, the volatile memory is typically erased when the embedded system is powered down. Accordingly, the nonvolatile memory, which typically does not require a power source to maintain stored data, may be used to store the code executed by the host while the embedded system is powered down. When the embedded system is powered up (e.g., when the embedded system enters a reset state), the code used by the host system may be loaded into the volatile memory and executed from the volatile memory by the host. The process of loading code stored in the non-volatile memory into the volatile memory and executing the code from the volatile memory may be referred to as code shadowing.

To maintain flexibility in accessing data in the embedded system, there may be a desire to transfer data between the host, volatile memory, and nonvolatile memory in a variety of ways. For example, there may be a desire to perform data transfers between the volatile memory and the host, and between the volatile memory and one or more nonvolatile memories. While maintaining flexibility in accessing data in the embedded system, there may also be a desire to reduce the cost and complexity of the interface between the host and the components of the memory system.

Accordingly, what is needed is an improved system and method for accessing memory in an embedded system.

### SUMMARY OF THE INVENTION

Embodiments of the invention generally provide a method and apparatus for controlling a shared bus. The shared bus is shared between a volatile memory device via a nonvolatile memory interface of the volatile memory and two or more nonvolatile memory controllers. In one embodiment, the method includes receiving a request from a first nonvolatile memory controller of the two or more nonvolatile memory controllers for control of the shared bus. In response to receiving the request, control of the shared bus is granted to the first nonvolatile memory controller if the priority for each of the two or more nonvolatile memory controllers indicates that control should be granted. When control is granted to the first nonvolatile memory controller, the first nonvolatile memory controller is the only nonvolatile memory controller of the two or more nonvolatile memory controllers which performs data access operations via the shared bus.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-D are block diagrams depicting aspects of an embedded systems according to embodiments of the invention;

FIGS. 2A-C are flow diagrams depicting processes for accessing data in an embedded system according to embodiments of the invention;

FIGS. 3A-D are diagrams depicting aspects of a first interface for accessing a shared bus according to one embodiment of the invention;

FIGS. 4A-D are diagrams depicting aspects of a second interface for accessing a shared bus according to one embodiment of the invention; and

FIGS. 5A-B are block diagrams depicting exemplary control registers and control pins according to embodiments of the invention.

### DETAILED DESCRIPTION OF THE PREFERRED EMBODIMENT

Embodiments of the invention generally provide methods and apparatus for controlling a shared bus. The shared bus is shared between a volatile memory device via a nonvolatile memory interface of the volatile memory and two or more nonvolatile memory controllers. In one embodiment, a method includes receiving a request from a first nonvolatile memory controller of the two or more nonvolatile memory controllers for control of the shared bus. In response to receiving the request, control of the shared bus is granted to the first nonvolatile memory controller if the priority for each of the two or more nonvolatile memory controllers indicates that control should be granted. When control is granted to the first nonvolatile memory controller, the first nonvolatile memory controller may be the only nonvolatile memory controller of the two or more nonvolatile memory controllers which performs data access operations via the shared bus. By providing exclusive control of the shared bus, embodiments of the invention may prevent devices from performing conflicting access operations via the shared bus.

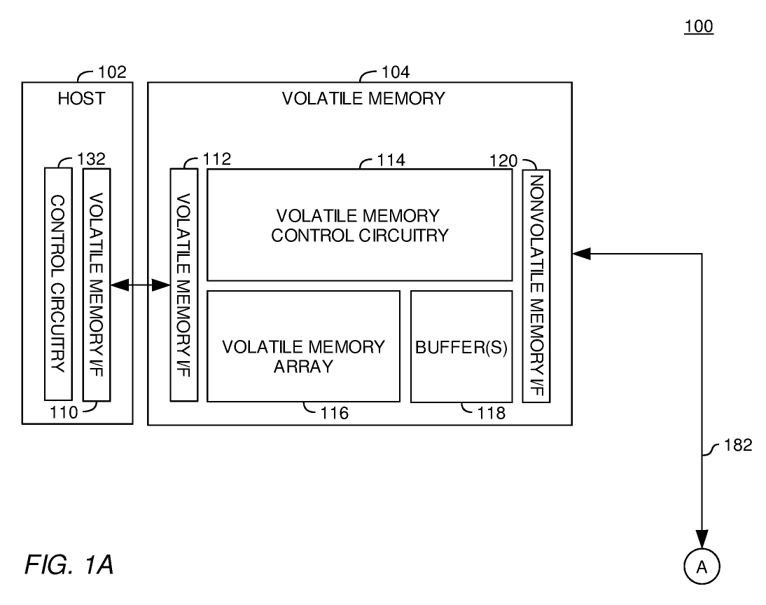

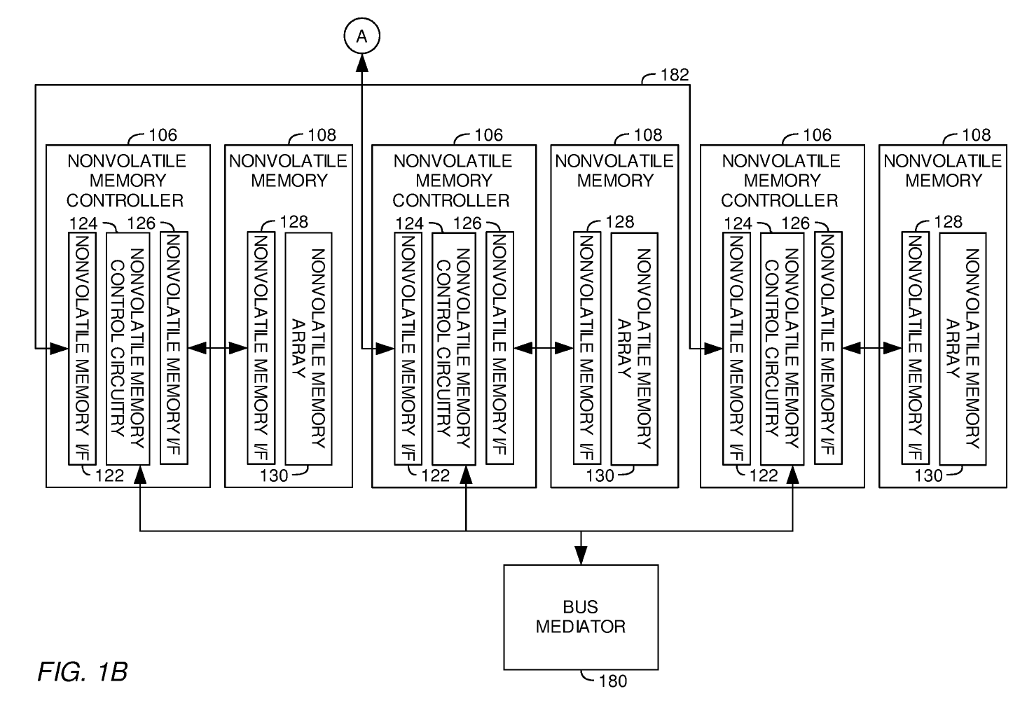

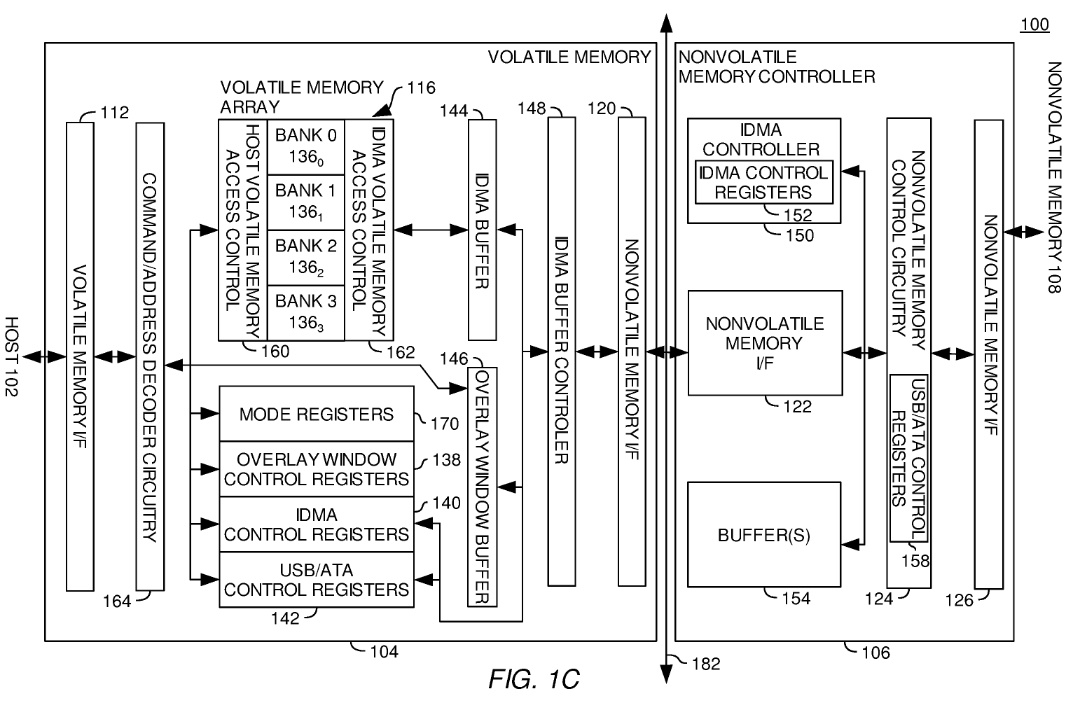

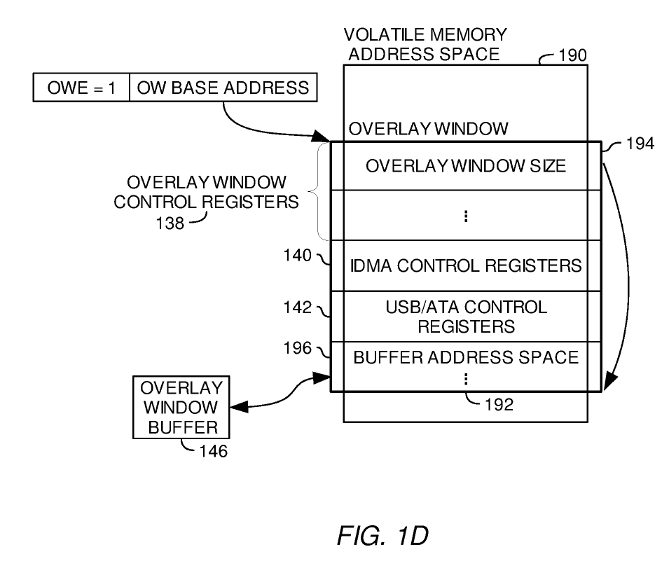

FIGS. 1A-B are block diagrams depicting an embedded system 100 according to one embodiment of the invention. As depicted, the embedded system 100 may include a host 102, a volatile memory 104, and multiple nonvolatile memory controllers 106 each connected to nonvolatile memories 108. The nonvolatile memory controllers 106 may be configured to access the volatile memory 104 via a shared bus 182. For example, each of the nonvolatile memory controllers 106 may share the same data, address, and control lines which form the shared bus 182. Simultaneous access across the shared bus by two or more nonvolatile memory controllers 106 may result in different information being transmitted simultaneously by separate nonvolatile memory controllers 106, and may thus result in errors. Accordingly, as described below, a bus mediator circuit 180 may be used to provide control of the shared bus 182 to one nonvolatile memory controller 106 at a time, thereby preventing simultaneous conflicting accesses to the shared bus 182.

In one embodiment, the host 102 may include control circuitry 132 and a volatile memory interface 110 for communicating with a volatile memory interface 112 of the volatile memory 104. In one embodiment, the volatile memory interface 112 may include an interface which conforms to the Joint Electron Device Engineering Council (JEDEC) Low Power Double Data Rate (LPDDR) synchronous dynamic random access memory (SDRAM) Specification. Optionally, any other appropriate volatile memory interface (e.g., utilizing DRAM interface control signals such as write enable (WE), row access strobe (RAS), column access strobe (CAS), and chip select (CS)) may be used.

The control circuitry 132 may be used, for example, to execute computer instructions and process data received from the volatile memory 104 or another location (e.g., a disk drive or other storage device). In some cases, the host 102 may also include additional circuitry, e.g., input/output (I/O) interfaces for receiving user input and additional interfaces to other embedded system components such as additional memory components, disk drives, and other devices. Also, the host 102 may utilize the volatile memory interface 112 to provide commands and information and to receive information from the volatile memory 104, nonvolatile memory controllers 106, and/or nonvolatile memories 108.

In one embodiment, the volatile memory 104 may include a volatile memory interface 112 for communicating with the host 102 and a nonvolatile memory interface 120 for communicating with the nonvolatile memory controllers 106 via the shared bus 182. The volatile memory 104 may act as a slave (e.g., the volatile memory 104 may be controlled by the other nonvolatile memory controllers 106 via the shared bus 182) with respect to both the host 102 and the nonvolatile memory controller 106. Optionally, the volatile memory 104 may be master with respect to the nonvolatile memory controller 106. The nonvolatile memory interface 120 may include any interface used to access the nonvolatile memory 108, including, for example, the write enable (WE), output enable (OE), and chip select (CS) control signals. As mentioned, in one embodiment, the bus mediator circuit 180, which may either be provided as part of a nonvolatile memory controller 106 or as a separate device, may be used to control sharing of the shared bus 182 between the nonvolatile memory controllers 106.

The volatile memory 104 may also include volatile memory control circuitry 114 for processing commands received via the volatile memory interface 112 and/or nonvolatile memory interface 120. The volatile memory 104 may further include a volatile memory array 116 for storing data and one or more buffers 118 for transferring data and/or commands between the host 102, volatile memory 104, nonvolatile memory controllers 106, and/or nonvolatile memories 108. In one embodiment, the buffers 118 may be dynamic RAM (DRAM) memory. Optionally, the buffers 118 may be static Ram (SRAM) memory. The volatile memory 104 may also include a nonvolatile memory interface 120 for communicating with the nonvolatile memory controllers 106.

In one embodiment of the invention, each nonvolatile memory controller 106 may include a first nonvolatile memory interface 122 for communicating with the volatile memory 104 via the shared bus 182 and a second nonvolatile memory interface 126 for communicating with a corresponding nonvolatile memory 108. Each nonvolatile memory controller 106 may also include nonvolatile memory control circuitry 124 for controlling data transfers between the volatile memory 104, nonvolatile memory controller 106, and nonvolatile memory 108. In one embodiment, each nonvolatile memory 108 may be accessed via a nonvolatile memory interface 128. Data in each nonvolatile memory 108 may be stored in the nonvolatile memory array 130.

FIG. 1C is a block diagram depicting further details of the volatile memory 104 and a single nonvolatile memory controller 106 according to one embodiment of the invention. As depicted, the volatile memory 104 may include command and address decoder circuitry 164 (e.g., as part of volatile memory control circuitry 114). When the command and address decoder circuitry 164 receives a command from the host 102 which accesses data in one of the banks 136 in the volatile memory array 116, the data may be accessed via the host volatile memory access control 160 for the volatile memory array 116. The volatile memory 104 may also provide mode registers 170 for controlling operation of the volatile memory 104, overlay window control registers 138 for controlling an overlay window, and an overlay window buffer 146 for transferring data between the components of the embedded system 100 as described in greater detail below.

In one embodiment of the invention, the volatile memory 104 may further provide internal direct memory access (iDMA) control registers 140 for controlling DMA transfers between the nonvolatile memory 108, nonvolatile memory controller 106, and volatile memory 104. As described below, modifying the iDMA control register settings in the volatile memory 104 may cause the volatile memory 104 to issue commands to the nonvolatile memory controller 106 causing corresponding changes to be made in iDMA control registers 152 in an iDMA controller 150 of the nonvolatile memory controller 106. Such changes may, for example, result in a command being issued to the iDMA controller 150 which causes a DMA transfer to be performed, e.g., between the volatile memory 104, a given nonvolatile memory controller 106, and a corresponding nonvolatile memory 108.

In one embodiment, the DMA transfer may, for example, utilize buffers 154 in the nonvolatile memory controller 106 to temporarily hold data being transferred between the nonvolatile memory 108 and the volatile memory 104. With respect to the volatile memory 104, the DMA transfer may utilize an iDMA volatile memory access control 162 to access the volatile memory array 116 (e.g., to read or write data for the DMA transfer). Data from the volatile memory array 116 may be transferred to or from an iDMA buffer 144 which may in turn be used to transfer data via the nonvolatile memory interface 120 of the volatile memory 104. An iDMA buffer controller 148 may be used to control the data transfer between the iDMA volatile memory access control 162, iDMA buffer 144, and nonvolatile memory interface 120 of the volatile memory 104.

In one embodiment, the volatile memory 104 may also include Universal Serial Bus (USB)/Advanced Technology Attachment (ATA) registers 142 which may be used to control USB/ATA functionality in the nonvolatile memory controller 106. For example, in one embodiment, when a change is made to the USB/ATA registers in the volatile memory 104, the volatile memory 104 may automatically cause a corresponding change to be made in USB/ATA control registers 158 in the nonvolatile memory control circuitry 124 of the nonvolatile memory controller 106. Thus, the host 102 may be able to access USB/ATA functionality of the nonvolatile memory controller 106 via the volatile memory 104.

In one embodiment of the invention, a portion of the volatile memory address space 190 (depicted in FIG. 1D) for the volatile memory 104 may be allocated to an overlay window 192 which may be used by the host 102 to issue commands to and transfer data between the volatile memory 104, nonvolatile memory controllers 106, and nonvolatile memories 105. The volatile memory address space 190 of the volatile memory 104 generally includes the range of addresses which may be accessed via the volatile memory interface 112 of the volatile memory 104. For example, if the volatile memory interface 112 provides a total of 18 address bits (e.g., two bank address bits BA0 and BA1 and 16 address bits A[15:0]), then the address space 190 of the volatile memory 104 may include 262,144 addresses (2 raised to the 18^{th} power), which may allow up to 256k of row entries (where each row entry corresponds to a given address) of data in the volatile memory 104 to be accessed.

In one embodiment, the overlay window 192 may be enabled or disabled, for example, as a result of a command received via the volatile memory interface 112 (e.g., by setting or clearing an overlay window enable bit, OWE). Furthermore, in some cases, the volatile memory addresses occupied by the overlay window 190 may be configurable. Thus, for example, the base address (OW Base Address) of the overlay window 192 as well as the size 194 of the overlay window 192 may be configurable by modifying control register settings in the volatile memory 104.

In some cases, by accessing addresses in the overlay window 192 via the volatile memory interface 112, the host 102 may be able to access data in the nonvolatile memory 108 as well as overlay window control registers 138, iDMA control registers 140, and USB/ATA control registers 142. Thus, the overlay window 192 may allow access to registers and memory arrays other than the volatile memory array 116 via the volatile memory interface 112. If an access command (e.g., a read or a write command) received via the volatile memory interface 112 does not fall within the range of addresses specified by the overlay window, then the access command may be used to access the volatile memory array 116. If the received address does fall within the overlay window 192, then the access command may be used to access other data such as data in the overlay window buffer 146 (via buffer address space 196) or control registers 138, 140, 142 in the volatile memory 104. The particular buffer portion or register 138, 140, 142 via the overlay window 192 may depend, for example, on the relative offset of the buffer address space 196 or register 138, 140, 142 within the overlay window 192.

Use of the overlay window 192 for issuing commands, as well as other aspects of communication in the embedded system 100 are described in greater detail in U.S. patent application Ser. No. 11/456,061, Attorney Docket No. QIMO/0263, entitled CONTROL PROTOCOL AND SIGNALING IN A NEW MEMORY ARCHITECTURE, filed Jul. 6, 2006, by Rom-Shen Kao, which is hereby incorporated by reference in its entirety. While described above with respect to using an overlay window 192 for accessing and issuing commands to the volatile memory 104, nonvolatile memory controllers 106, and nonvolatile memories 108, in general, embodiments of the invention may be utilized with any type of control mechanism (e.g., different interfaces using different interfaces including different connection pins or providing different commands) for communication and control between the host 102 and other components of the embedded system 100.

In one embodiment of the invention, the host 102 may issue commands to the volatile memory 104 and nonvolatile memory controllers 106 via the volatile memory interface 112 of the volatile memory 104. The commands may, for example, cause data to be transferred between one of the nonvolatile memories 108 and the volatile memory 104 via a nonvolatile memory controller 106. The commands may also cause data to be transferred between one nonvolatile memory 108 and another volatile memory 108 via two nonvolatile memory controllers 106. The commands may further modify control settings in the volatile memory 104, nonvolatile memory controllers 106, and/or nonvolatile memories 108.

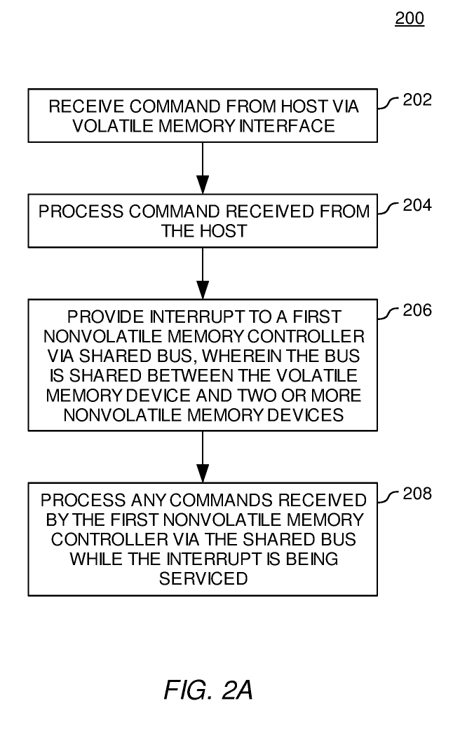

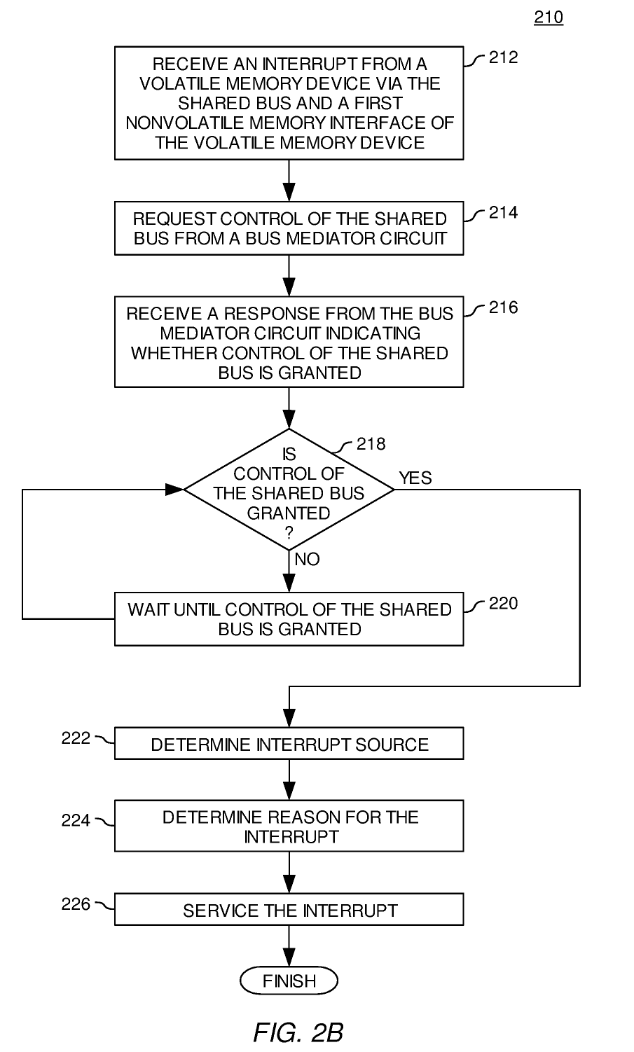

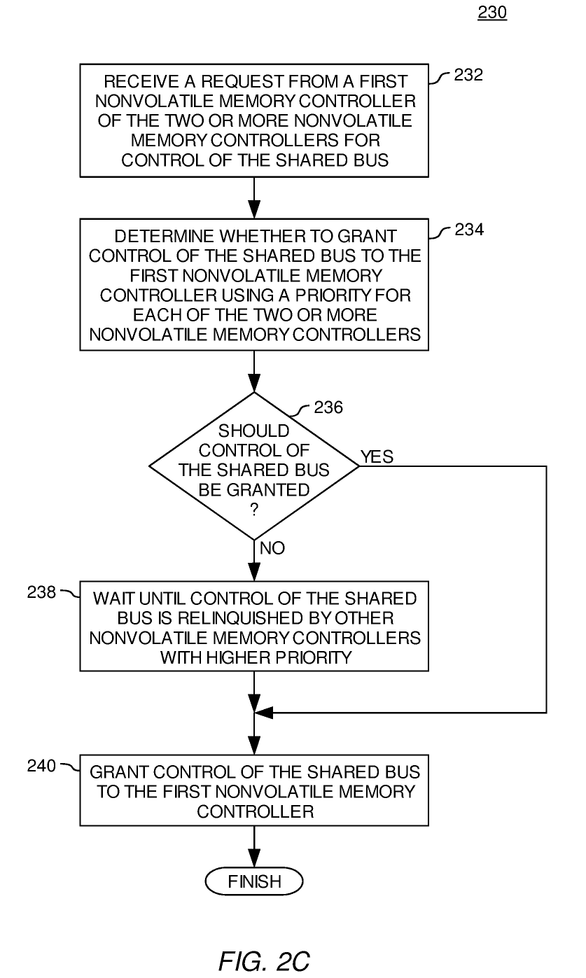

FIG. 2A is a flow diagram depicting a process 200 for issuing commands from the host 102 to a selected non-volatile memory controller 106 according to one embodiment of the invention. In one embodiment, as described above, the commands may be issued using the overlay window 192. The process 200 may begin at step 202 where a command is received from the host 102 via the volatile memory interface 112 of the volatile memory 104. The command received from the host 102 may then be processed at step 204, for example, to determine if performing the command requires usage of one or more of the nonvolatile memory controllers 106. For example, the command may indicate that a first nonvolatile memory controller 106 should perform a data transfer or that one or more of the control settings for a nonvolatile memory controller 106 should be modified.

Upon determining that the command requires usage of a first nonvolatile memory controller 106, the volatile memory device 104 may provide an interrupt to the first nonvolatile memory controller 106 via the shared bus 182 at step 206. For example, the volatile memory 104 may assert an interrupt signal and/or an interrupt vector across the shared bus 182 indicating which nonvolatile memory controller 106 is the target of the interrupt. Optionally, a separate interrupt signal may be provided for each nonvolatile memory controller 106 (e.g., via separate pins of the volatile memory 104) and the volatile memory 104 may only assert a given interrupt signal for the selected nonvolatile memory controller 106 if the received command targets the selected nonvolatile memory controller 106. As described below, upon receiving the interrupt, the first nonvolatile memory controller 106 may attempt to service the interrupt by requesting control of the shared bus 182 from the bus mediator 180. If the first nonvolatile memory controller 106 is able to obtain control of the shared bus 182, the volatile memory 104 may process any commands received by the first nonvolatile memory controller via the shared bus while the interrupt is being serviced at step 208.

As described above, after an interrupt if received by one of the nonvolatile memory controllers 106, the nonvolatile memory controller 106 may be configured to request control of the shared bus 182 from the bus mediator circuit 180. After obtaining exclusive control of the shared bus 182, the nonvolatile memory controller 106 may be configured to service the interrupt, as described below.

FIG. 2B if a flow diagram depicting a process 210 for obtaining control of the shared bus 182 according to one embodiment of the invention. The process 210 may begin at step 212 where an interrupt is received from the volatile memory device 104 via the shared bus 182 and the nonvolatile memory interface 120 of the volatile memory device 104. In response to receiving the interrupt, the nonvolatile memory controller 106 may request control of the shared bus 182 from the bus mediator circuit 180 at step 214. Control may be requested, for example, by asserting a control request signal applied to an input pin of the bus mediator circuit 180. Optionally, control may be requested using a more flexible interface capable of, for example, sending information such as the type of interrupt, priority of the interrupt, nonvolatile memory controller information, priority of the nonvolatile memory controller 106, etc.

At step 216, a response may be received from the bus mediator circuit 180 indicating whether control of the shared bus is granted. The response may include, for example, a control grant signal which is lowered to indicate that control is not granted or asserted to indicate that control is granted. At step 218, a determination may be made of whether control of the shared bus 182 is granted by the bus mediator 180.

If control of the shared bus 182 is not granted, the nonvolatile memory controller 106 requesting control may wait until control of the shared bus 182 is granted at step 220. For example, the nonvolatile memory controller 106 may poll the control grant signal provided by the bus mediator circuit 180 until the signal is asserted. Optionally, the nonvolatile memory controller 182 may go into a sleep state until the bus mediator circuit 180 asserts the control grant signal and wakes the nonvolatile memory controller 182 from the sleep state. In some cases, the nonvolatile memory controller 106 may also be configured with a timeout. If the bus mediator circuit 180 does not grant control of the shared bus 182 within the timeout period, the nonvolatile memory controller 106 may issue another request to the bus mediator circuit 180 or provide an error indication to the host 102, for example, via the nonvolatile memory interface 120 of the volatile memory 104.

If control of the shared bus is granted, the nonvolatile memory controller 106 which received the interrupt may determine the interrupt source at step 222. For example, an interrupt may be issued by the volatile memory 104 in response to a command received from the host 102 or in response to a request from the iDMA buffer controller 148 (e.g., the interrupt may be issued by the iDMA buffer controller 148 to request that the nonvolatile memory controller 106 a DMA transfer or a portion of a DMA transfer). Similarly, the interrupt may be issued by another nonvolatile memory controller 106.

The nonvolatile memory controller 106 may determine the interrupt source in any manner. For example, the interrupt source may be provided as an interrupt source vector via pins of the nonvolatile memory interface 122 and decoded by the nonvolatile memory controller 106. Optionally, nonvolatile memory controller 106 may provide a separate pin for each interrupt source, and the interrupt source may be determined from the pin on which the interrupt is received. As another example, the nonvolatile memory controller 106 may determine the interrupt source by reading from a location in the volatile memory 104 such as a memory mapped register corresponding to the nonvolatile memory controller 106 and configured to provide an indication (e.g., a value decoded by the nonvolatile memory controller 106) of the source of the interrupt.

At step 224, the nonvolatile memory controller 106 may determine the reason for the interrupt. For example, the interrupt may indicate that the host 102 has issued a command to the nonvolatile memory controller 106 to modify one or more of its control settings. The interrupt may also indicate that the nonvolatile memory controller 106 should perform a data transfer or part of a data transfer, for example, between the nonvolatile memory 108 and the volatile memory 104. As described above, such a data transfer command may be issued both by the host 102 and/or by DMA circuitry such as the iDMA buffer controller 148 in the volatile memory 104.

After determining the reason for the interrupt, the nonvolatile memory controller 106 may service the interrupt at step 226. For example, where the host 102 has provided new control settings for the nonvolatile memory controller 106 in a location in the volatile memory 104 (e.g., in a memory-mapped register), the nonvolatile memory controller 106 may download the new control settings from the volatile memory 104 via the shared bus 182 and the nonvolatile memory interface 120 of the volatile memory 104 and implement the new control settings. Where the host 102 or other circuitry in another device has requested that the nonvolatile memory controller 106 perform a data transfer, the nonvolatile memory controller 106 may retrieve a source address (e.g., for the volatile memory array 116, in a buffer 118, or in a nonvolatile memory array 130) and a destination address (e.g., to one of the other listed locations) and amount of data to be transferred. Information for the transfer may, for example, be retrieved from memory-mapped registers in the volatile memory 104. The nonvolatile memory controller 106, acting as master with respect to the volatile memory 104 and the corresponding nonvolatile memory 108, may then perform the requested transfer of data via the shared bus 182.

As described above, in one embodiment, the bus mediator 180 may be used to grant control of the shared bus 182. FIG. 2C is a flow diagram depicting a process 230 for granting control of the shared bus 182 according to one embodiment of the invention. At step 232, a request from a first nonvolatile memory controller 106 for control of the shared bus 182 may be received. At step 234, a determination of whether to grant control of the shared bus 182 to the first nonvolatile memory controller 106 may be made.

In one embodiment, the determination may be made using a priority for each of the two or more nonvolatile memory controllers 106 which share the shared bus 182. For example, affixed priority may be established between each of the nonvolatile memory controllers 106 which share the shared bus 182. Priority may also be established, for example, by determining a priority from an interrupt vector or other indication of the interrupt type, using round-robin scheduling, or using any other priority/scheduling mechanism known to those skilled in the art. Also, in some cases, control of the shared bus 182 may be granted on a first come, first serve basis. In one embodiment, each nonvolatile memory controller 106 may maintain control of the shared bus 182 as long as the nonvolatile memory controller 106 is performing an operation. Optionally, in some cases, a nonvolatile memory controller 106 in control of the shared bus 182 may temporarily lose control to another nonvolatile memory controller 106 and resume operation after control is returned.

At step 236, a determination is made of whether control of the shared bus 182 should be granted. If control of the shared bus 182 should not be granted (for example, if one or more other nonvolatile memory controllers 106 maintains priority for control of the shared bus 182), then at step 238, the bus mediator 180 may wait until control of the shared bus 182 is relinquished by other nonvolatile memory controllers 106 with higher priority. When a determination is made to grant control of the shared bus 182 to the first nonvolatile memory controller 106, then control of the shared bus 182 may be granted at step 240. Control of the shared bus 182 may, for example, be granted by asserting a shared bus control signal which is detected by the first nonvolatile memory controller 106.

In some cases, when granting control of the shared bus 182 to a first nonvolatile memory controller 106, a second nonvolatile memory controller 106 may be temporarily interrupted, for example, while the second nonvolatile memory controller 106 is performing a data transfer such as a DMA transfer. Where a second nonvolatile memory controller 106 is temporarily interrupted by a first nonvolatile memory controller 106, the second nonvolatile memory controller 106 may later be allowed to continue the interrupted data transfer after the first nonvolatile memory controller 106 has completed servicing its interrupt.

For example, when the second controller 106 is interrupted, the bus mediator 180 may store a record indicating that the second controller 106 was interrupted. After the first controller 106 has received control, services the interrupt, and relinquished control, the bus mediator 180 may then use the stored record to return control of the shared bus 182 to the second controller 106, thereby allowing the second controller 106 to resume the interrupted data transfer. In one embodiment, instead of using a record stored by the bus mediator 180, the second controller 106 may provide an indication to the bus mediator 180 that control should be returned after the first controller 106 has finished. For example, upon losing control, the second controller 106 may assert a control request signal to the bus mediator 180. After the first controller 106 has relinquished control to the bus mediator 180, the bus mediator 180 may then provide control of the shared bus 180 to the second controller 106 in response to the control request signal asserted by the second controller 106.

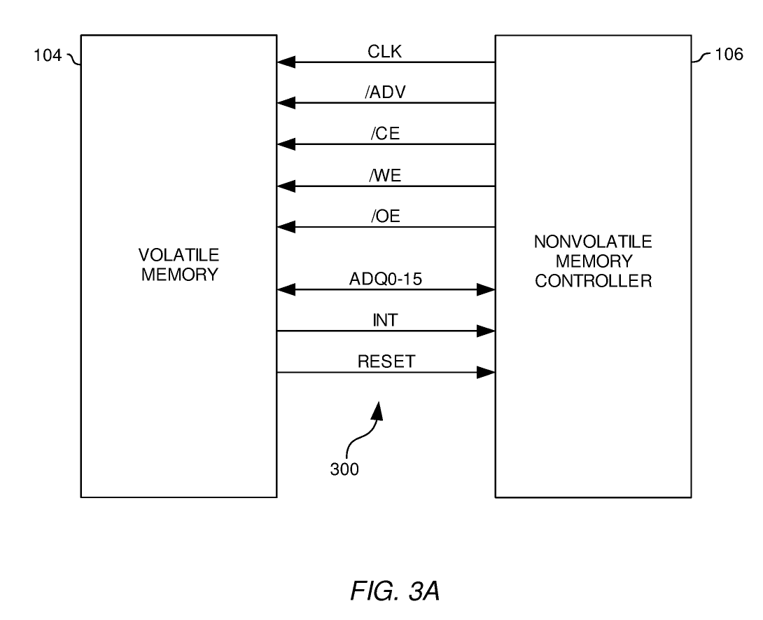

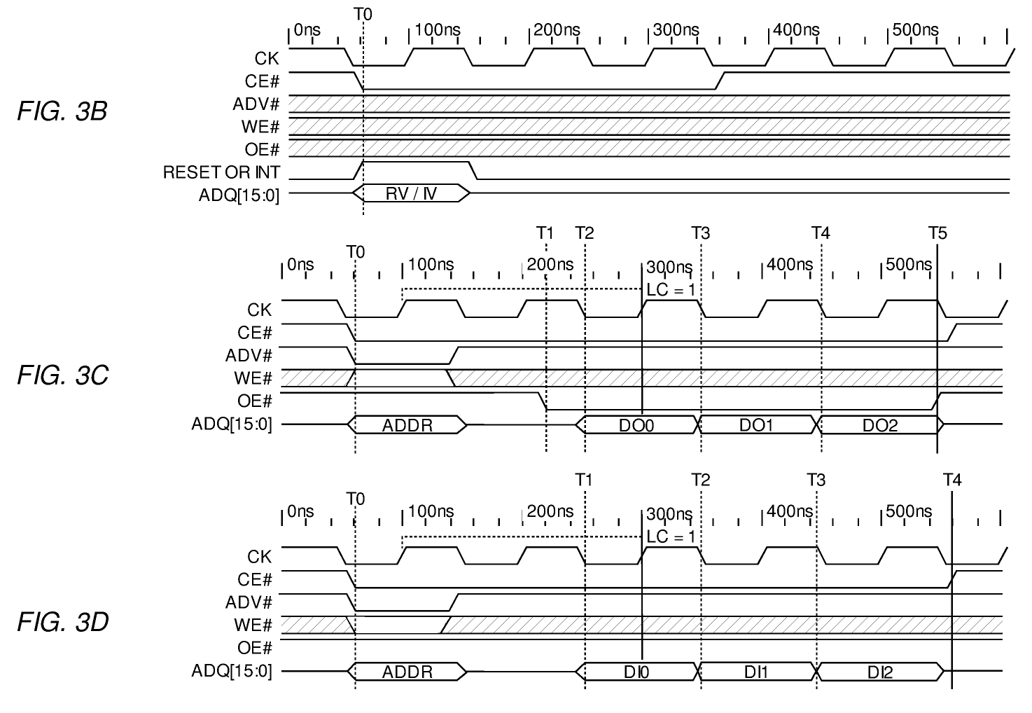

In general, devices 104, 106 connected to the shared bus 182 may communicate across the shared bus 182 using any appropriate type of interface. Two exemplary interfaces are described below with respect to FIGS. 3A-D and 4A-D.

FIG. 3A is a block diagram depicting a first interface 300 for communicating across the shared bus 182 according to one embodiment of the invention. While depicted with respect to a single volatile memory 104 and nonvolatile memory controller 106, the same depicted signals may be provided by each nonvolatile memory controller 106 connected to the shared bus 182. As depicted, the interface 300 may include a clock signal (CLK), control signals (/ADV, /CE, /WE, /OE) for the nonvolatile memory interface, and data and address bus connections (ADQ[0-15]).

In one embodiment, the depicted control signals may correspond to a pseudo-static random access memory (PSRAM) interface. As described below, the interface 300 may be used to perform synchronous burst operations. In some cases, the interface 300 may not utilize refresh configuration registers (RCR) or bus configuration registers (BCR). Also, in some cases, the interface 300 may omit wait signals, high address pins, and/or byte enable (UB/LB) signals.

In one embodiment, the interface 300 may also include an interrupt signal (INT) and reset signal (RESET). The interrupt signal may be used to provide an indication to the nonvolatile memory controller 106 when an interrupt has been issued. The reset signal may be used to reset the nonvolatile memory controller 106. In some cases, separate connections (e.g., connections which are not shared) may be provided for each reset and interrupt signal which is issued to a nonvolatile memory controller 106. Optionally, a single shared interrupt signal and shared reset signal may be provided to all nonvolatile memory controllers 106, and separate chip enable (/CE) signals may be provided to each controller 106 to indicate which controllers are receiving the interrupt signals and/or reset signals.

In one embodiment of the invention, the interface 300 may be used to issue a reset command to a nonvolatile memory controller 106. Issuing the reset command may be performed, for example, when the embedded system 100 is initiated (e.g., powered up) or if the nonvolatile memory controller 106 experiences an error. By resetting the nonvolatile memory controller 106, the nonvolatile memory controller 106 may be place in a defined state, for example, by loading predefined settings into controller memory and preparing the controller 106 to service any received interrupts. In some cases, multiple reset states may be provided (e.g., the nonvolatile memory controller 106 may be placed in one of multiple configurations after receiving a reset command) by providing a reset vector indicating which reset state should be assumed by the controller 106 after receiving the reset command.

FIG. 3B is a timing diagram depicting an exemplary operation for resetting or issuing an interrupt to a nonvolatile memory controller 106 using the interface 300 depicted in FIG. 3A according to one embodiment of the invention. As depicted, the reset operation may begin at time T0 where the chip enable signal /CE is lowered. In the case of a reset, the RESET signal may be asserted. In the case of an interrupt, the INT signal may be asserted. When the RESET signal is asserted, a value provided via the address and data bus ADQ[15:0] may indicate a reset vector for the reset command. When the INT signal is asserted, a value provided via the address and data bus ADQ[15:0] may indicate an interrupt vector (indicative of the source and/or type of interrupt) for the interrupt command.

In one embodiment of the invention, the interface 300 may be used to perform a burst read operation to read multiple data from an address within the volatile memory 104. The address may, for example, correspond to a buffer 118 or a location within the volatile memory array 116. During the burst read operation, a single burst read command and address are provided by the nonvolatile memory controller 106 via the command pins and address and data pins ADQ[15:0]. After the single burst read command and address are provided, subsequent data for the burst read command may be provided via the address and data pins ADQ[15:0].

FIG. 3C is a timing diagram depicting an exemplary burst read operation performed using the interface 300 depicted in FIG. 3A according to one embodiment of the invention. As depicted, the burst read operation may begin at time T0 where a burst read command is provided to a given nonvolatile memory controller 106 by lowering the chip enable (/CE) signal, lowering the address valid (/ADV) signal, raising the write enable (/WE) signal, maintaining a raised output enable (/OE) signal, and placing a read address on the address and data bus ADQ[15:0].

After receiving the burst read command, the volatile memory 104 may be configured to begin outputting data for the read command after a given latency (usually defined in clock cycles). For example, the latency may be specified either by changing settings within a control register of the volatile memory 104. The latency setting may also be specified by providing the setting in a command issued to the volatile memory 104. In the case depicted in FIG. 3C, with a latency setting (LC) of one (LC=1), the data for the burst read may be output two clock cycles after the burst read command is received. Thus, at time T1, the output enable (/OE) signal may be lowered. Beginning at time T2 and continuing at times T3 and T4, data for the burst read operation may be output on each falling clock (CLK) edge. In one embodiment, the output enable (/OE) signal may determine the length of the burst read command. Thus, the burst read operation may cease at time T5 when the output enable (/OE) signal is raised.

In one embodiment of the invention, the interface 300 may also be used to perform a burst write operation to an address in the volatile memory 104. During the burst write operation, a single burst write command and address are provided by the nonvolatile memory controller 106 via the command pins and address and data pins ADQ[15:0]. After the burst write command and address have been provided, subsequent data for the burst write command may also be provided via the same address and data pins ADQ[15:0].

FIG. 3D is a timing diagram depicting an exemplary burst write operation using the interface 300 depicted in FIG. 3A according to one embodiment of the invention. As depicted, the burst write operation may begin at time T0 where the chip enable (/CE) signal is lowered, the address valid (/ADV) signal is lowered, the write enable (/WE) is lowered, the output enable (/OE) signal is maintained at a high level, and a write address for the burst write command is placed on the address and data pins ADQ[15:0].

Similar to the burst read command, the volatile memory 104 may be configured to receive data for the burst write command after a specified latency. In the case depicted in FIG. 3D, with LC=1, the data may be provided by the nonvolatile memory controller 106 to the volatile memory 104 two clock cycles after the burst write command is issued by the nonvolatile memory controller 106. Thus, beginning at time T1 and continuing at times T2 and T3, data for the burst write command may be output by the nonvolatile memory controller 106 on the address and data pins ADQ[15:0]. In one embodiment, the chip enable (/CE) signal may be used to control the length of the burst write operation. Thus, the burst write operation may finish at time T4 when the chip enable (/CE) signal is raised by the nonvolatile memory controller 106.

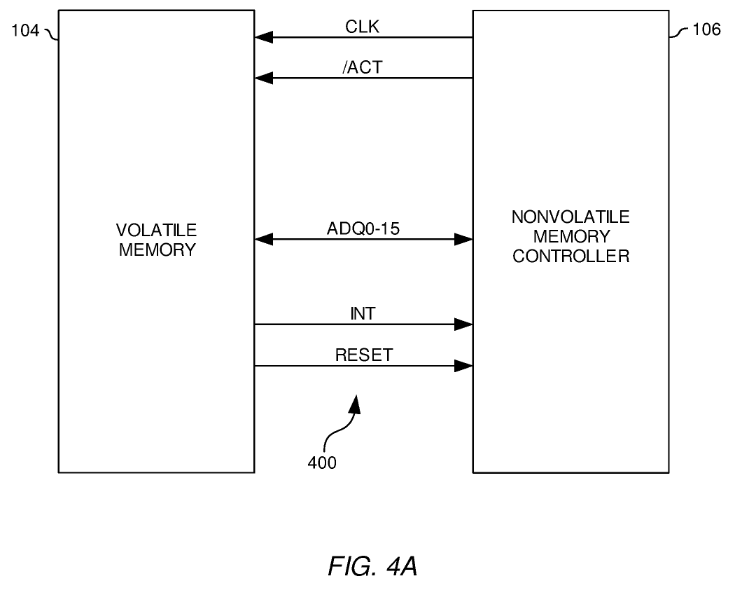

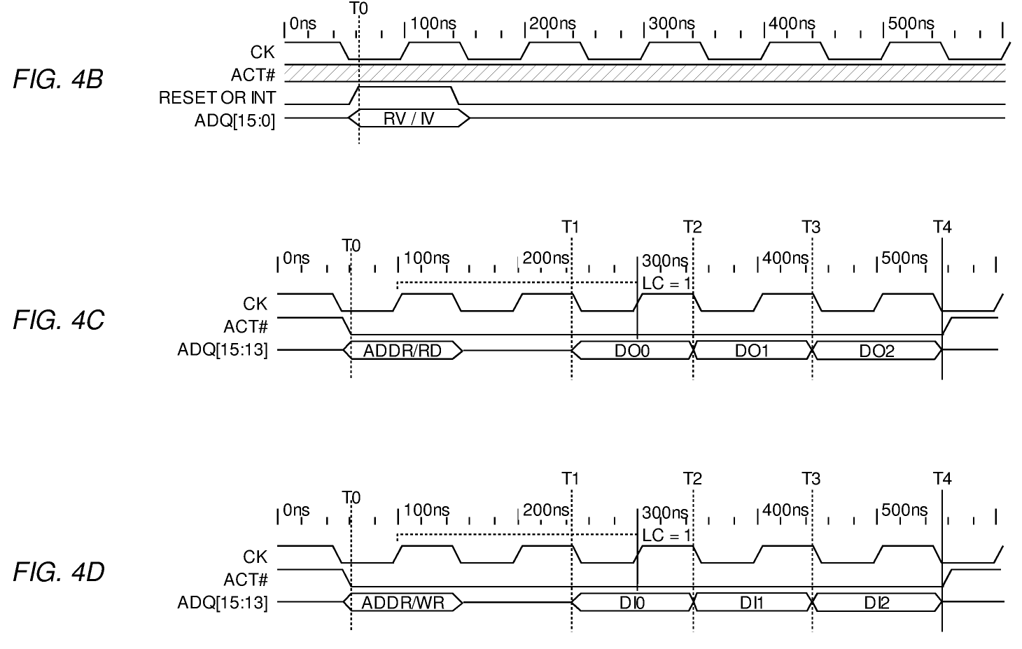

In one embodiment of the invention, the interface between a given nonvolatile memory controller 106 and the volatile memory 104 may be further simplified by reducing the number of dedicated command pins and sending command information across the address and data bus pins ADQ[15:0]. Thus, FIG. 4A is a block diagram depicting a second interface 400 for communicating across the shared bus 182 by sending command information across the address and data bus pins ADQ[15:0] according to one embodiment of the invention. As depicted the interface 400 may include a clock (CLK) signal, an activate (/ACT) signal which activates a given nonvolatile memory controller 106 connected to the shared bus 182, shared address and data bus pins (ADQ[15:0]), as well as the interrupt (INT) and reset (RESET) signals described above.

FIG. 4B is a timing diagram depicting an exemplary operation for resetting a nonvolatile memory controller 106 or providing an interrupt to a nonvolatile memory controller 106 using the interface 400 depicted in FIG. 4A according to one embodiment of the invention. As depicted, a reset command or interrupt command may be provided to the nonvolatile memory controller 106 at time T0. In the case of a reset command, the RESET signal may be asserted. In the case of an interrupt command, the INT signal may be asserted. Depending on the type of command issued (reset or interrupt), the address and data pins ADQ[15:0] may be used to provide a reset vector (RV) or interrupt vector (IV) as described above.

In one embodiment, command data may be provided via one or more pins of the address and data bus ADQ[15:0] as mentioned above. For example, three of the higher order pins of the address and data bus ADQ[15:13] may be used to provide a command code after the activate /ACT signal is lowered. For example, if the three higher order pins are used to transmit ‘000’ to the volatile memory 104, then the command may be a burst read command as described below with respect to FIG. 4C. if, however, the three higher order pins are used to transmit ‘001’, then the command may be a burst write command as described below with respect to FIG. 4D. When a given command is issued, the lower order pins ADQ[12:0] may be used to provide an address for the command code. After the command and address have been provided, each of the address and data bus pins ADQ[15:0] may subsequently be used for transmitting data for the received command.

FIG. 4C is a timing diagram depicting an exemplary burst read operation performed using the interface 400 depicted in FIG. 4A according to one embodiment of the invention. As depicted, the burst read command may begin at time T0 where the activate (/ACT) signal is lowered and the read command and address are provided via the address and data pins ADQ[15:0]. The read data may then be output via the address and data pins ADQ[15:0] beginning at time T1 and continuing at times T2 and T3. In one embodiment, the activate (/ACT) signal may be used to indicate the length of each burst command. Thus, the burst read command may finish at time T4 where the activate (/ACT) signal is raised.

FIG. 4D is a timing diagram depicting an exemplary burst write operation using the interface 400 depicted in FIG. 4A according to one embodiment of the invention. As depicted, the burst write command may begin at time T0 where the activate (/ACT) signal is lowered and the write command and address are provided via the address and data pins ADQ[15:0]. The write data may then be output via the address and data pins ADQ[15:0] beginning at time T1 and continuing at times T2 and T3. As described above, in one embodiment, the activate (/ACT) signal may be used to indicate the length of each burst command. Thus, the burst write command may finish at time T4 where the activate (/ACT) signal is raised.

As mentioned above, the host 102 may be configured to provide a variety of commands to the volatile memory 104 via an overlay window or other mechanism. After the volatile memory 104 has received the commands, the volatile memory 104 may provide an interrupt to one or more nonvolatile memory controllers 106 designated by the host 102. Also as described above, the interrupt may provide an interrupt vector which indicates the type of command which has been issued by the host 102 and/or where the nonvolatile memory controller 106 should obtain data for the command (e.g., such as op-codes for the command, addresses for the command, and/or data for the command). For example, the interrupt vector may provide either an address or a number corresponding to a register within the volatile memory 104 from which the nonvolatile memory controller 106 receiving the interrupt may obtain command data for servicing the interrupt.

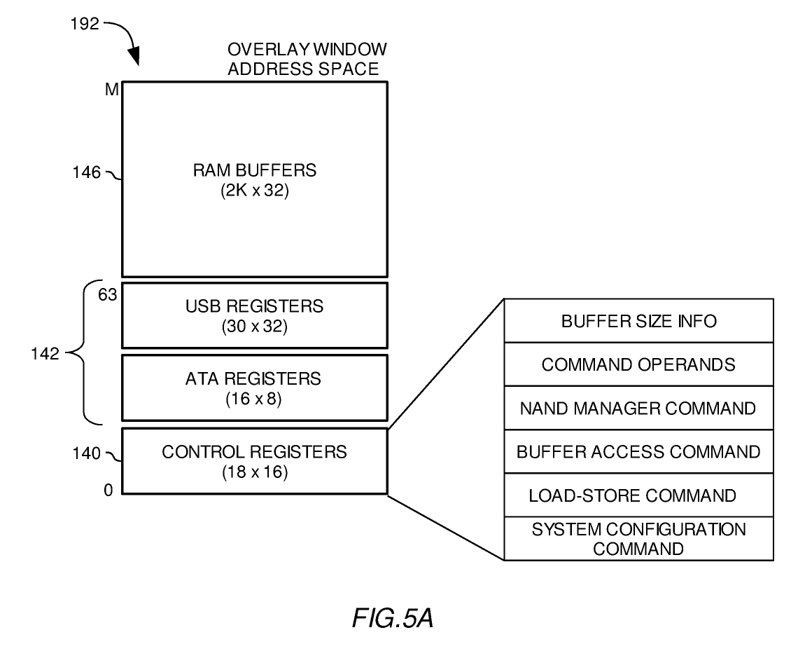

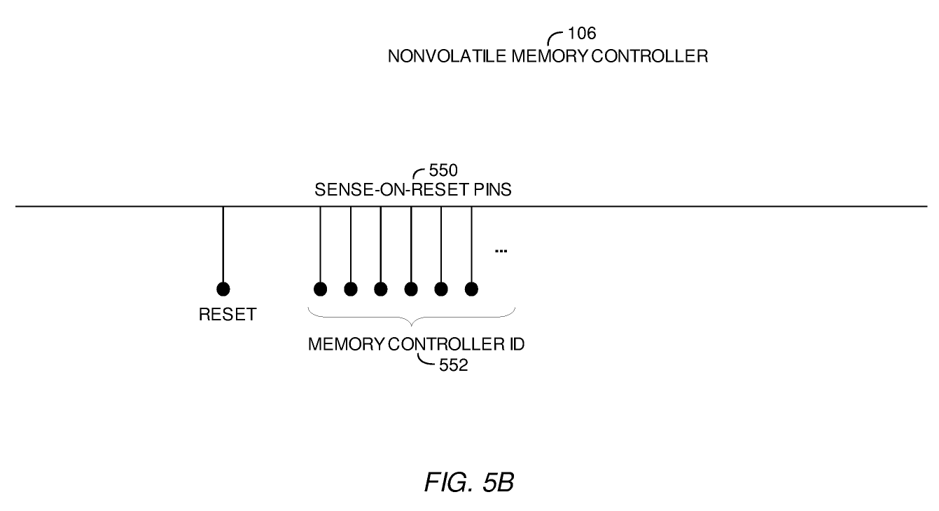

FIG. 5A is a block diagram depicting exemplary registers in the volatile memory 104 which the host 102 may use to communicate command data to the nonvolatile memory controllers 106. As depicted, the registers may be located within the overlay window address space 192 which may include random access memory (RAM) buffers 146 as well as the USB and ATA registers 142, and control registers 140. The control registers 140 may be used by the host 102 to provide buffer size information, command operands, NAND manager commands (for managing nonvolatile memory 108), buffer access commands, load-store commands, and/or configuration commands to one or more of the nonvolatile memory controllers 106.

As described above, in one embodiment of the invention, in order to provide different commands to different nonvolatile memory controllers 106, separate control signals (e.g., chip-enable (/CE) signals, activate (/ACT) signals, reset (RESET) signals, and/or interrupt (INT) signals) may be provided to each nonvolatile memory controller 106.

As another option for providing separate commands to each nonvolatile memory controller 106, the host 102 and/or volatile memory 104 may be configured to identify each separate nonvolatile memory controller 106 using a separate memory controller identification (ID). For example, the host 102 may use a separate memory controller ID when providing commands to the volatile memory 104, and the volatile memory may then use separate control signals as described above to communicate an interrupt or a reset command to a corresponding nonvolatile memory controller 106.

Optionally, instead of using separate control signals, the volatile memory 104 may be configured to provide a given memory controller ID to each nonvolatile memory controller 106 when issuing an interrupt or reset command. The given memory controller ID may then be examined by each nonvolatile memory controller 106 to determine whether the interrupt or reset command was issued to that specific nonvolatile memory controller 106. For example, each nonvolatile memory controller 106 may have a specific memory controller ID encoded into circuitry on the nonvolatile memory controller 106 during manufacturing. Optionally, the memory controller ID may be specified by burning one or more fuses in the nonvolatile memory controller 106 or by storing the memory controller ID into nonvolatile memory within the nonvolatile memory controller 106 itself.

Also, in one embodiment, the memory controller ID for each nonvolatile memory controller 106 may be specified using one or more pins connected to the nonvolatile memory controller 106. For example, the pins may be connected to pull-up or pull-down resistors by the manufacturer of the embedded system 100 in a manner specifying separate memory controller IDs for each nonvolatile memory controller 106. In one embodiment, as depicted in FIG. 5B, sense-on-reset (SOR) pins 550 may be used to specify the memory controller ID for each nonvolatile memory controller 106. When the nonvolatile memory controller 106 receives a reset (RESET) signal, the nonvolatile memory controller 106 may be configured to load the memory controller ID 552 provided via the sense-on-reset pins 550 and use the memory controller ID 552 when determining whether subsequent interrupts and/or reset commands issued by the volatile memory 104 are directed to that specific nonvolatile memory controller 106.

As described above, the bus mediator 180 may provide a simple and flexible tool for providing shared control of a shared bus 182. The shared control may ensure that multiple nonvolatile memory controllers 106 using the shared bus 182 to communicate data between a volatile memory device 104 and nonvolatile memory device 108 do not perform conflicting access operations via the shared bus 182.

While the foregoing is directed to embodiments of the present invention, other and further embodiments of the invention may be devised without departing from the basic scope thereof, and the scope thereof is determined by the claims that follow.

What is claimed is:

1. A method of controlling a shared bus, wherein the shared bus is shared between a volatile memory device via a nonvolatile memory interface of the volatile memory and two or more nonvolatile memory controllers, the method comprising:
receiving a request from a first nonvolatile memory controller of the two or more nonvolatile memory controllers for control of the shared bus; and
in response to receiving the request:
granting control of the shared bus to the first nonvolatile memory controller if a priority for each of the two or more nonvolatile memory controllers indicates that control should be granted, wherein, when control is granted to the first nonvolatile memory controller, the first nonvolatile memory controller is the only nonvolatile memory controller of the two or more nonvolatile memory controllers which performs data access operations via the shared bus.

2. The method of claim 1, wherein the shared bus is shared by only the volatile memory device and the two or more nonvolatile memory controllers.

3. The method of claim 1, wherein, after receiving the request and before granting control, control of the shared bus is taken from a second nonvolatile memory controller of the two or more nonvolatile memory controllers.

4. The method of claim 1, further comprising:
receiving control relinquished by the first nonvolatile memory controller after the nonvolatile memory controller has performed the data access operations via the shared bus.

5. The method of claim 1, wherein the request from the first nonvolatile memory controller is received in response to an interrupt sent from the volatile memory device to the first nonvolatile memory controller.

6. The method of claim 1, further comprising:
upon receiving control of the shared bus by the first nonvolatile memory controller, performing a data transfer from a nonvolatile memory device via a first nonvolatile memory interface of the nonvolatile memory controller to the volatile memory device via the shared bus and a second nonvolatile memory interface of the nonvolatile memory controller.

7. The method of claim 1, further comprising:
upon receiving control of the shared bus by the first nonvolatile memory controller, performing a data transfer from a nonvolatile memory device via a first nonvolatile memory interface of the nonvolatile memory controller to the volatile memory device via the shared bus and a second nonvolatile memory interface of the nonvolatile memory controller.

8. A bus mediator circuit, comprising:
a control interface to two or more nonvolatile memory controllers, wherein a shared bus is shared between a volatile memory device via a nonvolatile memory interface of the volatile memory and the two or more nonvolatile memory controllers; and
control circuitry configured to:
receive a request from a first nonvolatile memory controller of the two or more nonvolatile memory controllers for control of the shared bus; and
in response to receiving the request:
grant control of the shared bus to the first nonvolatile memory controller if the priority for each of the two or more nonvolatile memory controllers indicates that control should be granted, wherein, when control is granted to the first nonvolatile memory controller, the first nonvolatile memory controller is the only nonvolatile memory controller of the two or more nonvolatile memory controllers which performs data access operations via the shared bus.

9. The bus mediator circuit of claim 8, wherein the shared bus is shared by only the volatile memory device and the two or more nonvolatile memory controllers.

10. The bus mediator circuit of claim 8, wherein the control circuitry is further configured to:
after receiving the request and before granting control, take control of the shared bus from a second nonvolatile memory controller of the two or more nonvolatile memory controllers.

11. The bus mediator circuit of claim 8, wherein the control circuitry is further configured to:
receive control relinquished by the first nonvolatile memory controller after the nonvolatile memory controller has performed the data access operations via the shared bus.

12. The bus mediator circuit of claim 8, wherein the request from the first nonvolatile memory controller is received in response to an interrupt sent from the volatile memory device to the first nonvolatile memory controller.

13. The bus mediator circuit of claim 8, wherein the bus mediator circuit is included as part of one of the two or more nonvolatile memory controllers.

14. A method of accessing a shared bus, wherein the shared bus is shared by a volatile memory device and two or more nonvolatile memory controllers, the method comprising:
receiving an interrupt from a volatile memory device via the shared bus and a first nonvolatile memory interface of the volatile memory device; and
in response to receiving the interrupt:
requesting control of the shared bus from a bus mediator circuit;
receiving a response from the bus mediator circuit indicating whether control of the shared bus is granted; and
if control of the shared bus is granted, servicing the interrupt using the shared bus, wherein the shared bus is not used by a given nonvolatile memory controller when control is not granted.

15. The method of claim 14, wherein servicing the interrupt comprises:
receiving control of the shared bus;
performing a data transfer of data between a nonvolatile memory device via a second nonvolatile memory interface and a nonvolatile memory data bus; and
performing a data transfer of the data between the volatile memory device via the first nonvolatile memory interface and the shared bus.

16. The method of claim 14, wherein servicing the interrupt comprises:
receiving control of the shared bus;
performing a data transfer of data between a nonvolatile memory device via a second nonvolatile memory interface and a nonvolatile memory data bus; and
performing a data transfer of the data between one of the two or more nonvolatile memory devices via a third nonvolatile memory interface and the shared bus.

17. The method of claim 14, further comprising:
receiving control of the shared bus;
performing a first portion of a data transfer of data between a nonvolatile memory device and the volatile memory device via the shared bus;
relinquishing control of the shared bus while one of the two or more nonvolatile memory devices services a second interrupt; and
upon control of the shared bus being returned, performing a second portion of the data transfer.

18. The method of claim 14, wherein the first nonvolatile memory interface comprises command pins for providing command information and address pins for providing address information and performing data transfer of non-address information.

19. The method of claim 14, wherein the first nonvolatile memory interface comprises address pins configured to provide command information, address information, and perform data transfer of non-address information.

20. A nonvolatile memory controller, comprising:
a first nonvolatile memory interface configured to communicate with a volatile memory device using a bus shared between the nonvolatile memory controller and at least one other nonvolatile memory controller;
a second nonvolatile memory interface configured to communicate with a nonvolatile memory device; and
control circuitry configured to:
receive an interrupt from the volatile memory device via the shared bus and the first nonvolatile memory interface of the volatile memory device; and
in response to receiving the interrupt:
request control of the shared bus from a bus mediator circuit;
receive a response from the bus mediator circuit indicating whether control of the shared bus is granted; and
if control of the shared bus is granted, service the interrupt using the shared bus, wherein the shared bus is not used by the nonvolatile memory controller when control is not granted.

21. The nonvolatile memory controller of claim 20, wherein servicing the interrupt comprises:
receiving control of the shared bus;
performing a data transfer of data between the nonvolatile memory device via the second nonvolatile memory interface and a nonvolatile memory data bus; and
performing a data transfer of the data between the volatile memory device via the first nonvolatile memory interface and the shared bus.

22. The nonvolatile memory controller of claim 20, wherein servicing the interrupt comprises:
receiving control of the shared bus;
performing a data transfer of data between the nonvolatile memory device via the second nonvolatile memory interface and a nonvolatile memory data bus; and
performing a data transfer of the data between the at least one other nonvolatile memory controller via the shared bus.

23. The nonvolatile memory controller of claim 20, wherein the control circuitry is further configured to:
receive control of the shared bus;
perform a first portion of a data transfer of data between the nonvolatile memory device and the volatile memory device via the shared bus;
relinquish control of the shared bus while the at least one other nonvolatile memory controller services a second interrupt; and
upon control of the shared bus being returned, perform a second portion of the data transfer.

24. The nonvolatile memory controller of claim 20, wherein the first nonvolatile memory interface comprises command pins for providing command information and address pins for providing address information and performing data transfer of non-address information.

25. The nonvolatile memory controller of claim 20, wherein the first nonvolatile memory interface comprises address pins configured to provide command information, address information, and perform data transfer of non-address information.

26. A system, comprising:
a volatile memory device with a volatile memory interface and a nonvolatile memory interface;
a host processor configured to access the volatile memory via the volatile memory interface;
two or more nonvolatile memory controllers;
a shared bus, wherein the bus is shared between the two or more nonvolatile memory controllers and the volatile memory device via the nonvolatile memory interface; and
bus mediator circuitry comprising:
a control interface to the two or more nonvolatile memory controllers; and
control circuitry configured to:
receive a request from a first nonvolatile memory controller of the two or more nonvolatile memory controllers for control of the shared bus; and
in response to receiving the request:
grant control of the shared bus to the first nonvolatile memory controller if the priority for each of the two or more nonvolatile memory controllers indicates that control should be granted, wherein, when control is granted to the first nonvolatile memory controller, the first nonvolatile memory controller is the only nonvolatile memory controller of the two or more nonvolatile memory controllers which performs data access operations via the shared bus.

27. The system of claim 26, wherein the shared bus is shared by only the volatile memory device and the two or more nonvolatile memory controllers.

28. The system of claim 26, wherein the control circuitry is further configured to:
after receiving the request and before granting control, take control of the shared bus from a second nonvolatile memory controller of the two or more nonvolatile memory controllers.

29. The system of claim 26, wherein the control circuitry is further configured to:
receive control relinquished by the first nonvolatile memory controller after the nonvolatile memory controller has performed the data access operations via the shared bus.

30. The system of claim 26, wherein the request from the first nonvolatile memory controller is received in response to an interrupt sent from the volatile memory device to the first nonvolatile memory controller.

31. The system of claim 26, wherein the bus mediator circuit is included as part of one of the two or more nonvolatile memory controllers.
